(19) United States
(12) Patent Application Publication
(10) Pub. No.: US 2013/0324170 A1
(43) Pub. Date: Dec. 5, 2013

(54) SHORT MESSAGING SERVICE (SMS) OVER EVOLVED PACKET CORE USING WIFI ACCESS

(71) Applicant: Interdigital Patent Holdings, Inc., Wilmington, DE (US)

(72) Inventor: Mahmoud Watfa, Saint Leonard (CA)

(21) Appl. No.: 13/906,442

(22) Filed: May 31, 2013

Related U.S. Application Data
(60) Provisional application No. 61/653,625, filed on May 31, 2012.

(51) Int. Cl. H04W 4/14

(52) U.S. Cl. CPC H04W 4/14
USPC 455/466

(57) ABSTRACT

Disclosed herein are systems and methods for short messaging service (SMS) over evolved packet core using WiFi access. According to an aspect, a method may be implemented at a wireless transmit/receive unit (WTRU). The method may include generating a short messaging service (SMS) message. The method may also include communicating the SMS message to an access point via a WiFi connection for delivery to a mobility management entity (MME).

### CROSS-REFERENCE TO RELATED APPLICATION

This application claims the benefit of U.S. Provisional Patent Application No. 61/653,625, filed May 31, 2012, the content of which is hereby incorporated by reference in its entirety.

### BACKGROUND

Solutions that use non-3GPP radio access technology as a means to provide Internet connections by using the 3GPP as the core network have been investigated. For example, some solutions are provided to allow Wireless Transmit/Receive Units (WTRUs), such as user equipment (UE), to use a non-3GPP access technology for having a Packet Data Network (PDN) connection to the PDN gateway (PDN GW), and hence an Internet connection. This is depicted in FIG. 1, which illustrates an example architecture for using non-3GPP Access to establish an IP connection via the Evolved Packet Core. As can be seen from the example architecture shown in FIG. 2, a trusted non-3GPP access 202 or an untrusted non-3GPP access 204 may be used to establish a PDN connection to a PDN gateway (GW) 206, and hence the WTRU may access the Internet.

Moreover, the non-3GPP accesses may not be coupled or integrated with the 3GPP radio access network (RAN) and even though the WTRU may maintain its PDN connection if the WTRU uses 3GPP RAN, there may be no interaction between 3GPP access and non-3GPP access for this purpose. The core network (EPC) may be responsible for maintaining this IP connection as the WTRU changes its access technology from 3GPP to non-3GPP or vice versa.

### SUMMARY

Disclosed herein are systems and methods for sending a short messaging service message (SMS) over evolved packet core using a non-3GPP access technology, such as a WiFi access technology. According to an example, a method may be implemented at a Wireless Transmit/Receive Unit (WTRU). The method may include generating a short messaging service (SMS) message. The method may also include communicating the SMS message to an access point via a non-3GPP connection, e.g., a WiFi connection, for delivery to a mobility management entity (MME).

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed examples may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example radio access network and an example core network that may be used within the communications system illustrated in FIG. 1A;

FIG. 1E is a system diagram of an example radio access network and an example core network that may be used within the communications system illustrated in FIG. 1A;

FIG. 2 illustrates an example non-3GPP access (trusted or untrusted) that may be used to establish a PDN connection to the PDN GW;

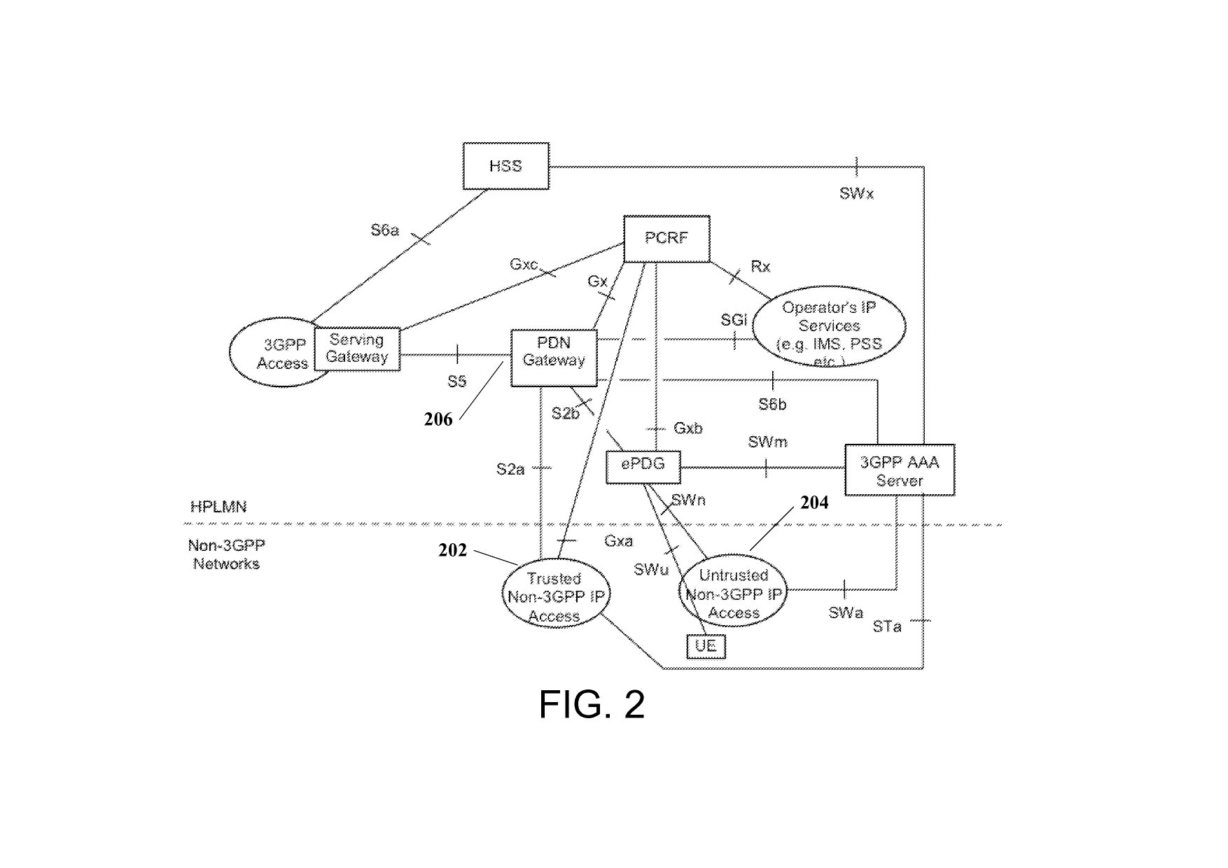

FIG. 3 is a block diagram illustrating an example system;

FIG. 4 is a flow chart illustrating a NAS Decision to use 3GPP or non-3GPP Access for SMS Transmission;

FIG. 5 is a flow chart illustrating an example method that may be performed by an SMS manager to decide what Access to use for SMS transmission;

FIG. 6 illustrates example SMS entity probes of the SMS manager to decide on what access to use for SMS transmission;

FIG. 7 illustrates an example interface between the NAS entity and the non-3GPP access (lower layer); and

FIG. 8 illustrates an example interface between an AP and an eNB.

### DETAILED DESCRIPTION

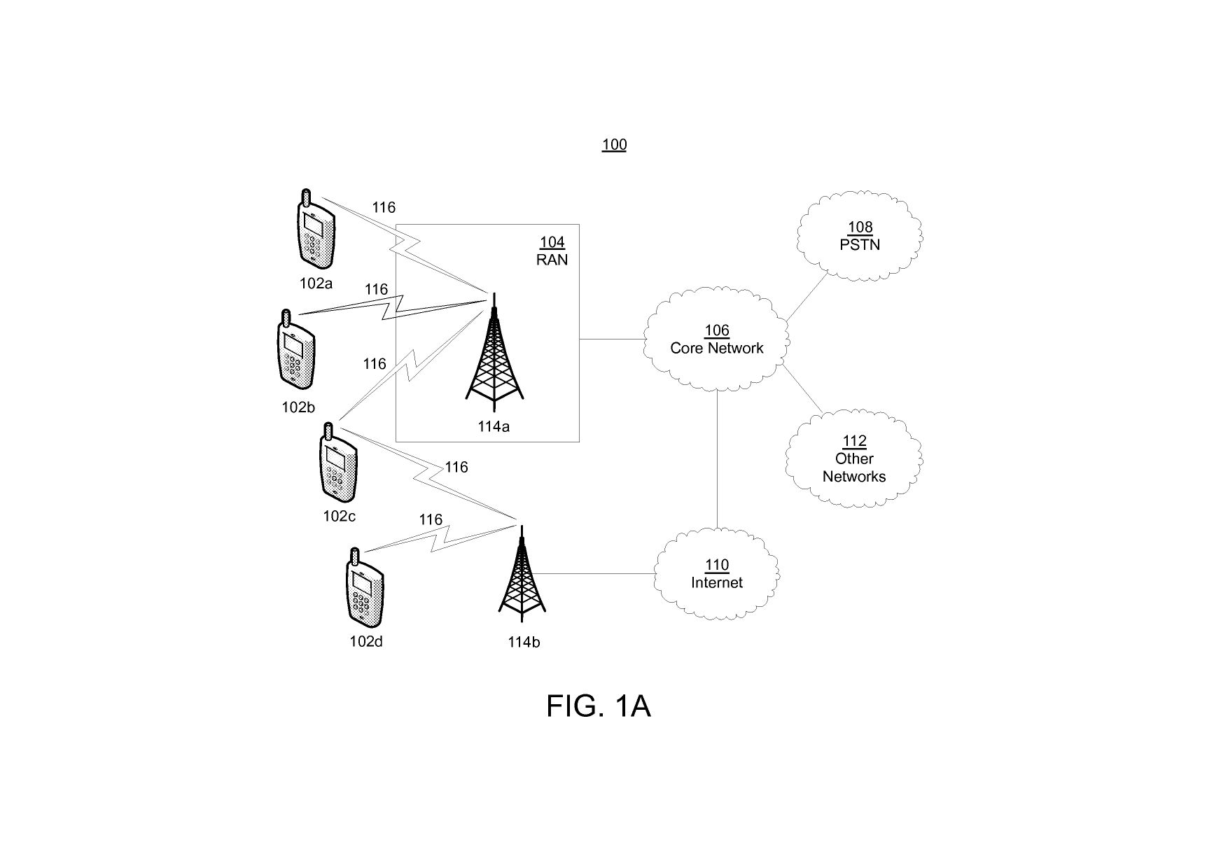

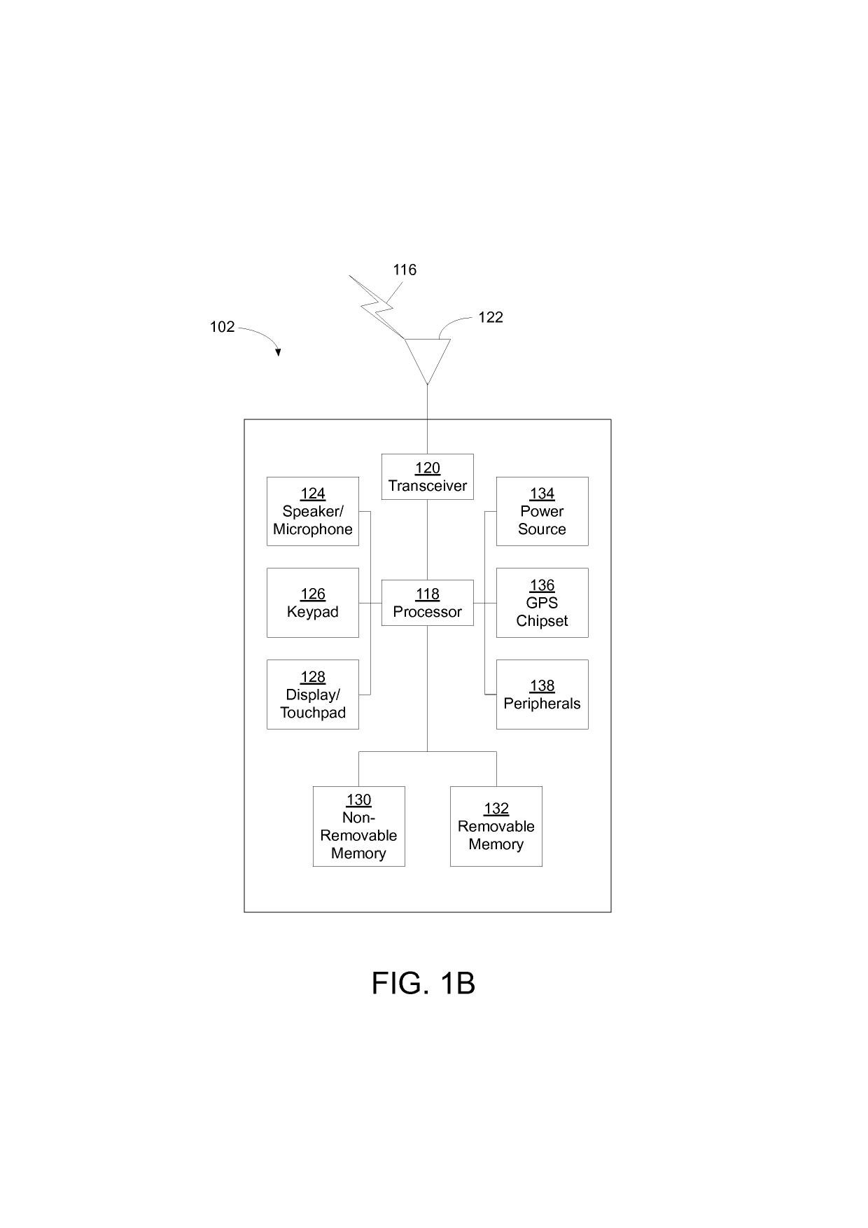

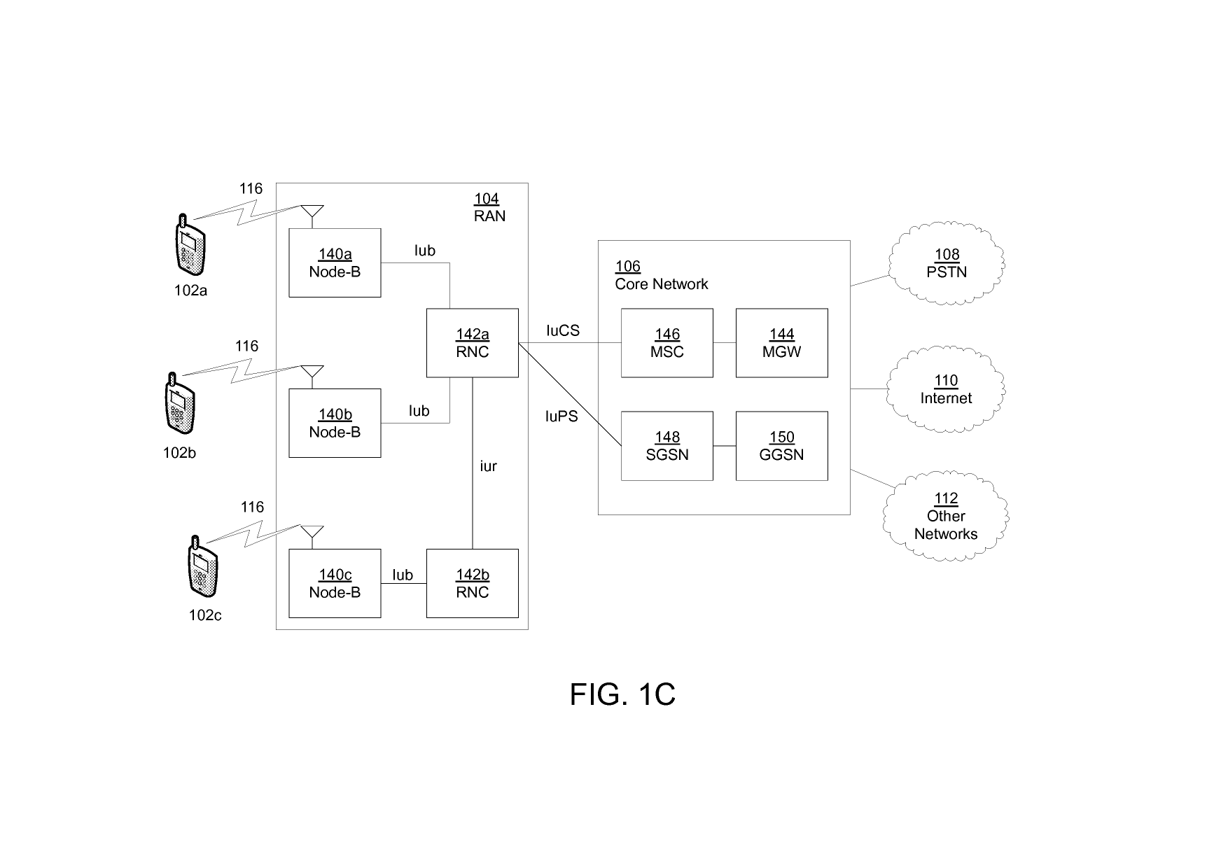

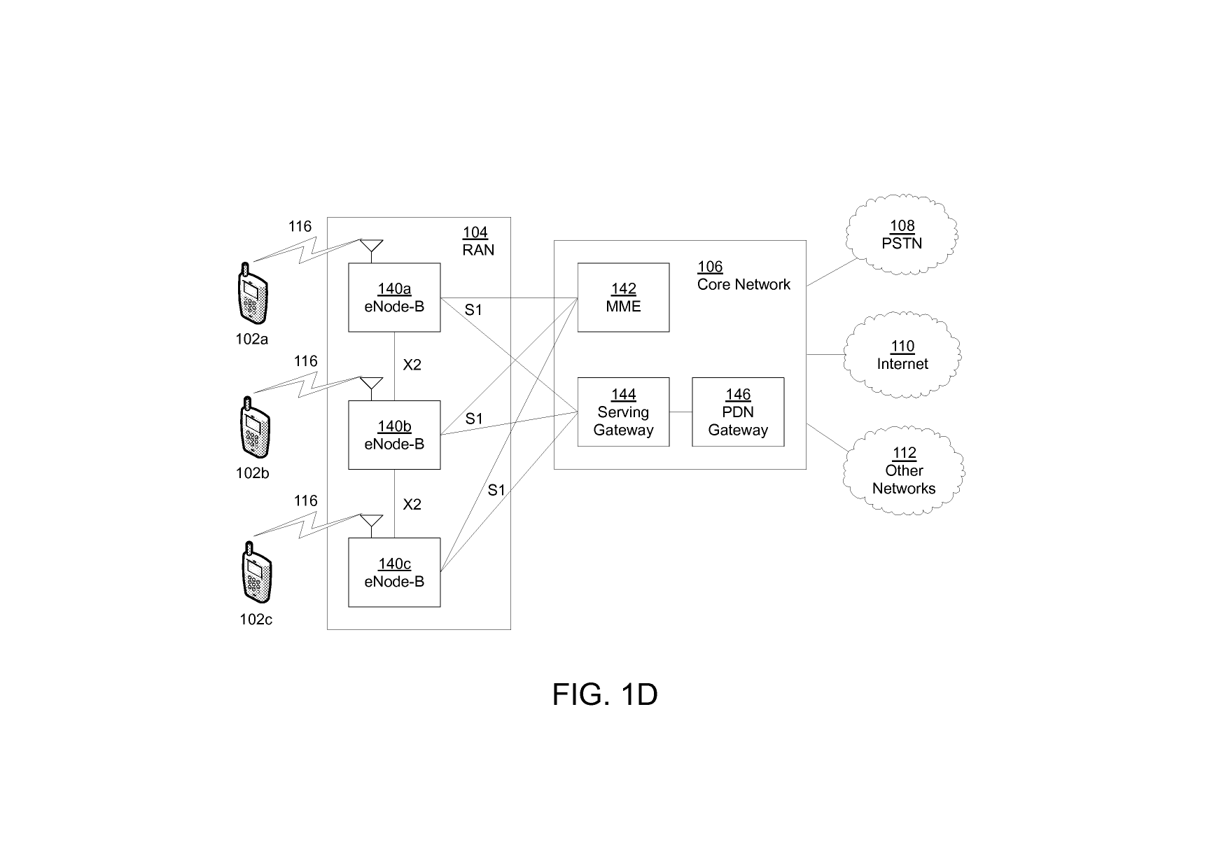

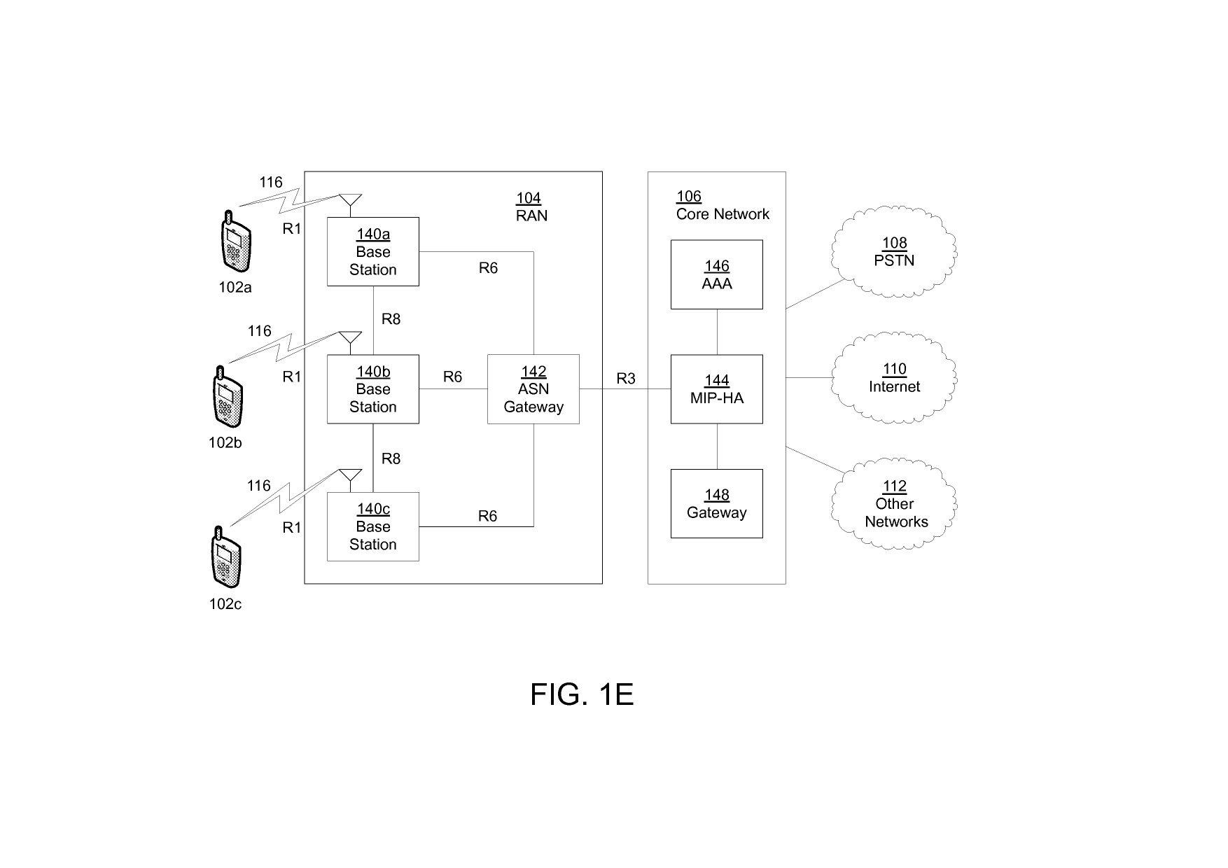

FIG. 1A is a diagram of an example communications system 100 in which one or more disclosed examples may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed examples contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one example, the base station 114a may include three transceivers, e.g., one for each sector of the cell. In another example, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as disclosed herein, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another example, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other examples, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one example, the base station 114b and the WTRUs 102c, 102d may implement a radio technology such as IEEE 802.11 to establish a wireless local area network (WLAN). In another example, the base station 114b and the WTRUs 102c, 102d may implement a radio technology such as IEEE 802.15 to establish a wireless personal area network (WPAN). In yet another example, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. The components, functions, and features described with respect to the WTRU 102 may also be similarly implemented in a base station.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one example, the transmit/receive element 122 may be an antenna configured to transmit and/or receive RF signals. In another example, the transmit/receive element 122 may be an emitter/detector configured to transmit and/or receive IR, UV, or visible light signals, for example. In yet another example, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one example, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. The WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other examples, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an example.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an example. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an example.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and, for example, traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to an example. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an example. The eNode-Bs 140a, 140b, 140c may each include one or more transceivers for communicating with the WTRUs 102a, 102b, 102c over the air interface 116. In one example, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1D, the eNode-Bs 140a, 140b, 140c may communicate with one another over an X2 interface.

The core network 106 shown in FIG. 1D may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and, for example, traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to an example. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 140a, 140b, 140c, and an ASN gateway 142, though it will be appreciated that the RAN 104 may include any number of base stations and ASN gateways while remaining consistent with an example. The base stations 140a, 140b, 140c may each be associated with a particular cell (not shown) in the RAN 104 and may each include one or more transceivers for communicating with the WTRUs 102a, 102b, 102c over the air interface 116. In one example, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and, for example, traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Recently, there has been an effort in 3GPP to study a tighter coupling between 3GPP and non-3GPP access technologies. An increase in applications requesting IP data connections is likely to cause an overload to the 3GPP RAN, which may be a bottleneck for wireless communication, especially in view of the increase in the number of handsets in the market. The number of smartphones is expected to keep increasing, and so is the trend for IP-based applications, some of which have high data rates. Thus, using both 3GPP and non-3GPP access for IP connections may improve the system performance and increase capacity.

Machine-type devices may be deployed that use the 3GPP system to send or receive data. These devices may be regular WTRUs, e.g., have the same capabilities of a non-machine-type WTRU even though they may be configured to operate as low priority devices. Thousands of such devices may be deployed in the network, and as a result, methods may be employed to avoid network congestion at both the RAN and core network (CN) level. Some of these devices may transmit a small amount of data at any time interval. In addition, the transmissions may be sporadic and, as a result, a large number of idle-to-connected mode transitions may be used to cater for such sporadic data. This may cause a decrease in system performance if many WTRUs simultaneously attempt to go to connected mode to transmit data. Such transitions may contribute to a large amount of signaling at both the radio and CN level and, hence, the system as a whole.

Some WTRUs may have very small data to transmit to the network. Such data may be transmitted via IP or using Short Message Service (SMS). SMS is a data service supported by mobile networks, such as GSM, and WTRUs, such as mobile telephones. SMS facilitates the communication of small amounts of data, such as text messages. The amount of data communicated in SMS is typically smaller than some other types of messages, such as email messages. The control plane, e.g., SMS may be used to send the small data; hence, the WTRU may not have an IP address. This may reduce the burden on IP address allocation as the number of machine type devices is expected to keep increasing. If these devices need to send a small burst of data, then the use of SMS can be an efficient method for machine-type communication.

In LTE, SMS may be transmitted over a Non Access Stratum (NAS) protocol and the WTRU may forego falling back or changing its radio access technology to perform SMS in the circuit switched (CS) domain like it does for voice calls using CS fallback (CSFB). For mobile originated SMS transmission, the WTRU may encapsulate the SMS in the Uplink NAS Transport message and sends it to a mobility management entity (MME). The transmission may be performed over the signaling radio bearer and not over the user plane. In order to transmit an SMS, a WTRU may go to connected mode if it is in idle mode. In idle mode, both the MME and the WTRU may maintain the WTRU's active EPS bearer context at the NAS layer, even though no resources such as radio bearers may be active in idle mode. The service request procedure may be used to take the WTRU from idle to connected mode. The service request procedure may trigger the establishment of network resources for the WTRU's active EPS bearer concepts. Thus, upon transition of a WTRU to connected mode, the MME may set up the resources on the S1 interface. This may trigger the eNB to set up radio resources for active EPS bearer contexts. Once the WTRU is in connected mode, it may then send SMS using NAS messages and not the user plane, e.g., not radio bearers that are established for the default or dedicates EPS bearers.

In view of the foregoing, it is desired to provide improvements in SMS systems.

A WTRU in idle mode may first go to connected mode to send an SMS. An idle-to-connected mode transition may trigger the establishment of radio and S1 resources for active EPS bearer contexts that the WTRU has.

The WTRU may generate signaling at both the radio (e.g., RACH procedure and RRC connection reconfiguration) and core network levels (e.g., S1AP signaling and signaling between the MME and SGW), which can establish radio and S1 resources. The WTRU may then use signaling radio bearers to send SMS and may forego using the established resources for transmitting SMS. These resources can remain active and unused unless the WTRU has uplink IP data to send.

The WTRU's transmission pattern for SMS may be sporadic and may frequent with a frequency that may be longer than the network's internal inactivity timer that is used to decide when the WTRU should be put back to idle mode. Thus, for multiple transmissions, the WTRU may go through several idle-to-connected mode transitions and hence generate signaling at both the radio and S1 interfaces to setup resources that are actually not needed for the service requested by the WTRU.

Some signaling, e.g., unnecessary signaling can also occur for a mobile-terminated SMS when the WTRU is in idle mode. This and other difficulties may be addressed by the presently disclosed subject matter.

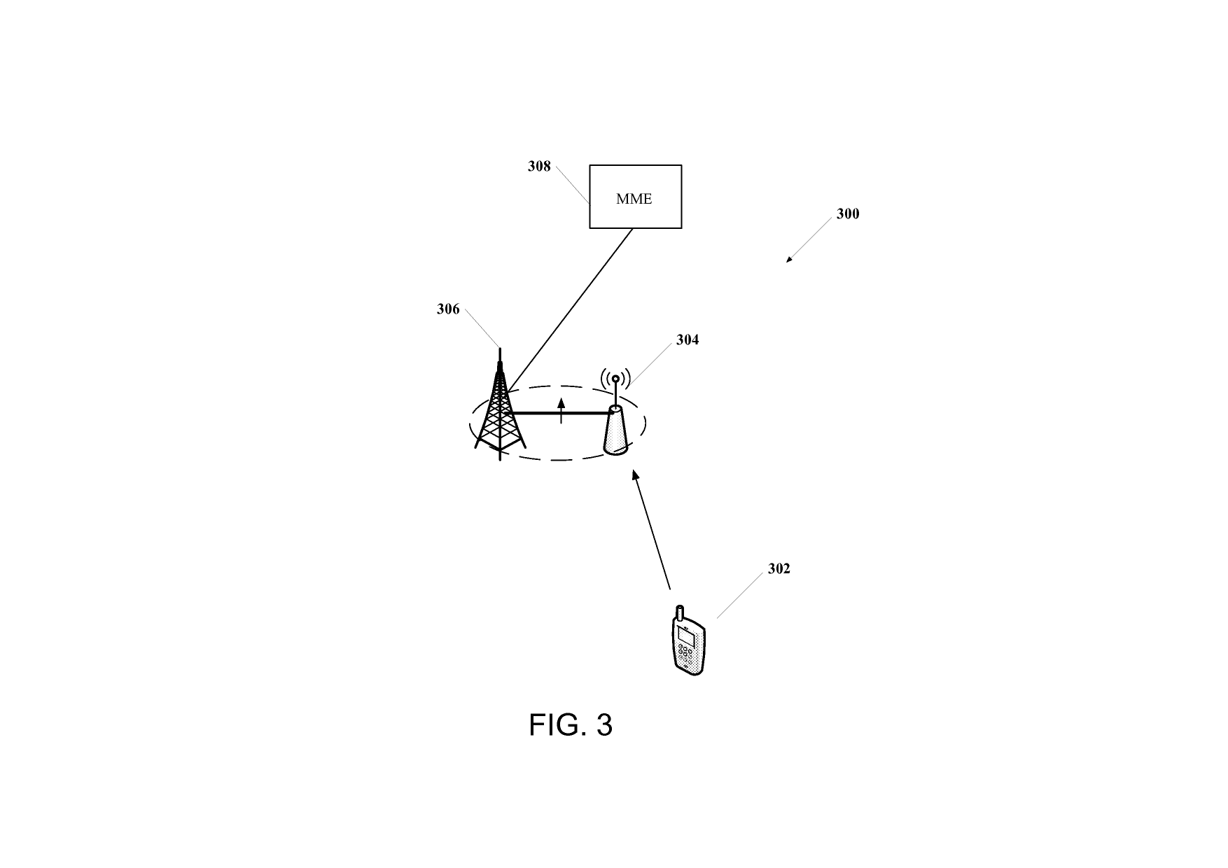

FIG. 3 depicts an example system 300 in accordance with an example of the present subject matter. Referring to FIG. 3, a WTRU 302 and the network may be configured to exchange capability information regarding the support of SMS over WiFi (SoW). The WTRU 302 may send an SMS over the WiFi access technology to a WiFi access point (AP) 304, e.g., when in an idle mode with the network, e.g., with no RACH performed in LTE. The AP 304 may then verify the message (which may be sent at any layer, e.g., MAC, IP, and the like) and may understand that the message carries an SMS, as further disclosed herein. The AP 304 can remove the SMS message and can send it to the eNB or HeNB 306 using an interface disclosed herein, along with other WTRU identification (e.g., S-TMSI). The AP 304 and the eNB or HeNB 306 may be implemented as a single entity or as separate entities that interact tightly with one another. The eNB or HeNB 306 may then forward the SMS to an MME 308 along with other received information, such as WTRU identification that may have been received from the AP. This may be done using S1AP messages, which may be modified. The MME 308 may receive the SMS from the eNB or HeNB 306 and may verify the identity of the WTRU that triggered this message. The MME 308 may then process the SMS, e.g., as if it was received from a WTRU that is in connected mode in LTE (using UL NAS Transport message), e.g., as if the SMS was received from a WTRU that used E-UTRAN. The MME 308 may forego setting up resources for a user plane. The MME 308 may then forward the SMS accordingly, e.g., using existing procedures.

Methods to send SMS over WiFi are disclosed herein. However, the methods disclosed herein do not preclude the use of any other non-3GPP accesses such as WiMax. Thus, the methods disclosed herein may apply to any other non-3GPP technology. The use of WiFi is one non-limiting example. Moreover, while certain examples are disclosed in the context of using LTE as the 3GPP technology, it will be appreciated that the principles disclosed herein may also be applicable to UMTS or GERAN, where similar nodes and functionalities may exist.

In an example, capability indication for SMS over WiFi may be provided. Both the WTRU and the network may indicate their support for SMS over WiFi (SoW). The network may indicate the support using any of the following methods: RRC messages, which may be dedicated or broadcast, for a particular cell, area, MME, or PLMN; NAS messages; and/or OMA DM or OTA, or ANDSF. The network may also identify the WiFi AP that supports this capability. The identification may be any identity such as, but not limited to, a MAC address of the AP.

The non-3PP technology may also include an indication for the support of this feature, e.g., in a WiFi MAC layer. This indication may also be accompanied with the identity of the PLMN(s) with which the AP is associated. The AP may be associated with multiple PLMNs, e.g., as in network sharing scenario. This information (e.g., support of service and other 3GPP related identification) may be broadcast by the AP or provided in dedicated (e.g., MAC) messages to the WTRU.

The WTRU may indicate its support using any of the following methods: NAS messages, e.g., in a network capability information element (IE) or any other IE; RRC messages using an IE; and/or an RRC message. The WTRU may also send an RRC or NAS message to indicate to the network that it has associated with an AP, e.g., one that broadcasts support of SMS transmission as disclosed herein, and the WTRU may indicate the AP's identity, such as a MAC address. If support is indicated via RRC messages, the eNB may then indicate to the MME that the WTRU has associated with or connected to an AP and may also indicate the AP's identity. This may be done with an S1AP message.

The network may indicate to the WTRU whether this service is supported for WTRUs in idle mode (e.g., when an SMS message is available for sending while the WTRU is in idle mode), or for WTRUs in connected mode (e.g., even if the WTRU is already in connected mode, it should use WiFi or other non-3GPP access to send the SMS), or both. Also, the network may indicate if this service is to be used for mobile-originated SMS, or mobile-terminated SMS, or both. Also, the network can indicate if the service is to be used for a subset of WTRUs, e.g., WTRUs that access the system as low priority device, and the like.

Additional subscription information may be defined to indicate whether or not a WTRU or subscriber is allowed to use SMS over WiFi (SoW), for a given cell, area, MME, or PLMN, or for a given set of WiFi AP. This information may be defined in the HSS and may be downloaded to the core network (e.g., MME) node upon registration of the WTRU. Also, the core network nodes, e.g., MMEs, may exchange this information during inter-MME handovers or MME-to-SGSN handovers in case of LTE-to-UTRAN handovers, or vice versa.

Also, the subscription information may be defined for roaming scenarios or VPLMN. In this case, the VPLMN may get the WTRU information regarding this service from the home PLMN.

In an example, one or more triggers may be defined in order for the WTRU to start using SoW. In an example, a trigger may be made upon indication from the network to do so, e.g., via NAs or RRC messages (e.g., in a Tracking Area Update Accept message or in RRC Connection Reconfiguration message).

In another example, a trigger may be made upon indication of the network support, as disclosed herein, for the service. In this example, the network may indicate, e.g., via RRC or NAS messages, that the use of AP (a list of well identified APs, e.g., using MAC addresses) is now allowed. The network may perform this indication, for example, by defining bits in RRC messages (e.g., the system information messages) or in NAS messages.

In another example, a trigger may be made upon entering a well-known cell, area, MME, PLMN, or CSG cell. In another example, a trigger may be made upon detection of a non-3GPP AP or upon detection of support of this service using non-3GPP technology as disclosed herein. In another example, a trigger may be made upon association with or connection establishment with a non-3GPP AP, with an indication of support for the service. In another example, a trigger may be made upon configuration using OMA DM, OTA, ANDSF, and/or based on configuration in the USIM.

In another example, a trigger may be made upon a change of setting by the user via the user interface of the device. The user may also choose what access technology is to be used by the WTRU for SMS. This may be done for every SMS to be sent, for example, or for a specific configured time, or some combination thereof.

As another example, the WTRU may use SMS over WiFi when it camps on a particular CSG/HeNB. The WTRU may maintain a list of HeNB/CSGs that support this service (e.g., it is known that these cells connect to an AP), or a list of eNB identities that support this service. When a WTRU camps on any of these cells, it may start using SoW.

The WTRU may also maintain a list of APs (e.g., identified by the MAC address or in another way) that are known to support this service. The WTRU may start using this service when it detects these APs or establishes a connection or association with the APs. The APs may be in priority order.

In another example, a trigger may be made when the WTRU accesses the system as a low priority device, or as any other device or mode, which may be defined later. A change of WTRU mode of operation, e.g., when a WTRU starts operating as a low priority device or as any other device or mode may trigger the use of SoW.

A WTRU may start using SMS over non-3GPP access if the WTRU is handed over to a cell that supports this feature, e.g., to a cell that connects to an AP. The WTRU may be informed in the handover message that the target supports this feature or connects to an AP. The network may also indicate to the WTRU the AP with which the WTRU should be associated (or a list of APs, in a priority order). This may also be applicable to other cases that are not related to handover, e.g., when a WTRU camps on a cell or goes to connected mode on a cell.

For any of these examples, the WTRU may also inform the network that it has associated with an AP, e.g., after the WTRU knows that the AP supports the service. The WTRU may send any NAS message to indicate to the network (e.g., MME) that the WTRU is under coverage of an AP or has associated with an AP. The WTRU may also provide the identification of the AP, e.g., its MAC address or any other identity. The MME may respond back to the WTRU with a NAS message to indicate if the AP supports the service, and/or if the WTRU is allowed to get such a service from this AP, and the like.

The WTRU may send an RRC message to the network to indicate that the WTRU is under coverage of an AP or has associated with an AP. The WTRU may also provide the identification of the AP, e.g., its MAC address or any other identity. The eNB may be configured with information such that it may decide whether or not the service is allowed for the WTRU, or it may request the core network to provide such information. Based on the configured information of the eNB, or based on a response from the core network (e.g., MME) the eNB may send an RRC message to indicate to the WTRU whether the service is allowed for the WTRU over an identified AP. The network (e.g., MME or eNB) may also provide the WTRU with a list of APs that provide a specific service, and the WTRU may indicate to the network when it associates or connects with any of these APs or with any AP. The WTRU may maintain a list of APs that provide the service or that are allowed for the WTRU to obtain such a service. The WTRU may add or delete entries from this list if the network indicates that the service is allowed or not allowed, respectively.

Furthermore, the WTRU may also maintain a list of eNBs, CSGs, etc., that are known to contain an AP and may take any of the action disclosed herein upon camping on these cells, after detection of an AP.

The network may also push information to the WTRU (also possibly via ANDSF, OMA DM, OTA) about availability of APs on a cell level, location area level, etc. The information may also contain an indication about the type of service available, e.g., SMS over WiFi, and whether or not the WTRU is allowed such as a service.

The network may also provide the WTRU with policies (also possibly via ANDSF, OMA DM, and/or OTA) about when to use a non-3GPP access for such services (e.g., SMS or other), what APs to use, mode of operation that is allowed to use such a service (e.g., when a WTRU is configured as a low priority device, or other), and the like.

The triggers and/or methods disclosed herein may also be used to terminate the service. The explicit or implicit methods disclosed herein may also be used to indicate to the WTRU which APs are not allowed or when the WTRU should stop using the service. For example, the WTRU may stop using this service when it moves out of a cell/eNB/CSG/HeNB/PLMN/tracking area/inter-MME handover/inter-system handover and the like. In addition, it may occur when an AP indicates that the service is not supported or temporarily not allowed.

The WTRU may stop using such a service when it moves away or disconnects from an AP, or an eNB, CSG, etc. that is known to connect to an AP. The WTRU may indicate to the network that it is leaving or has disconnected from an AP or an eNB, CSG, etc. that is known to connect to an AP. This may be done, for example, via NAS messages or RRC messages. If done with RRC messages, the eNB may in turn inform the core network about the event. The core network may then choose to deliver SMS and/or other services entirely over the 3GPP system.

The WTRU or system may stop using SMS over non-3GPP access when the WTRU is handed over to another cell, if the cell does not connect to an AP. After a handover, a WTRU may also indicate to a target cell that it was using some services (e.g., one or more services such as SMS) over non-3GPP access, and it may also provide an indication of the non-3GPP AP (e.g., a MAC address or any other identity). A source cell may also indicate to the target during handover that the WTRU was or was not connected to an AP (e.g., with an identity of the AP, e.g., its MAC address, or other identity information). This information may also be passed by the core network.

In an example, the WTRU may already be associated with (e.g., connected to) a non-3GPP AP and may already be aware that SoW is supported. The WTRU may be configured to send SMS over WiFi or may do so when the WTRU is in idle mode with the 3GPP system, e.g., LTE. The SMS may be transmitted to the AP regardless of whether this is done while in connected or idle mode with the 3GPP system.

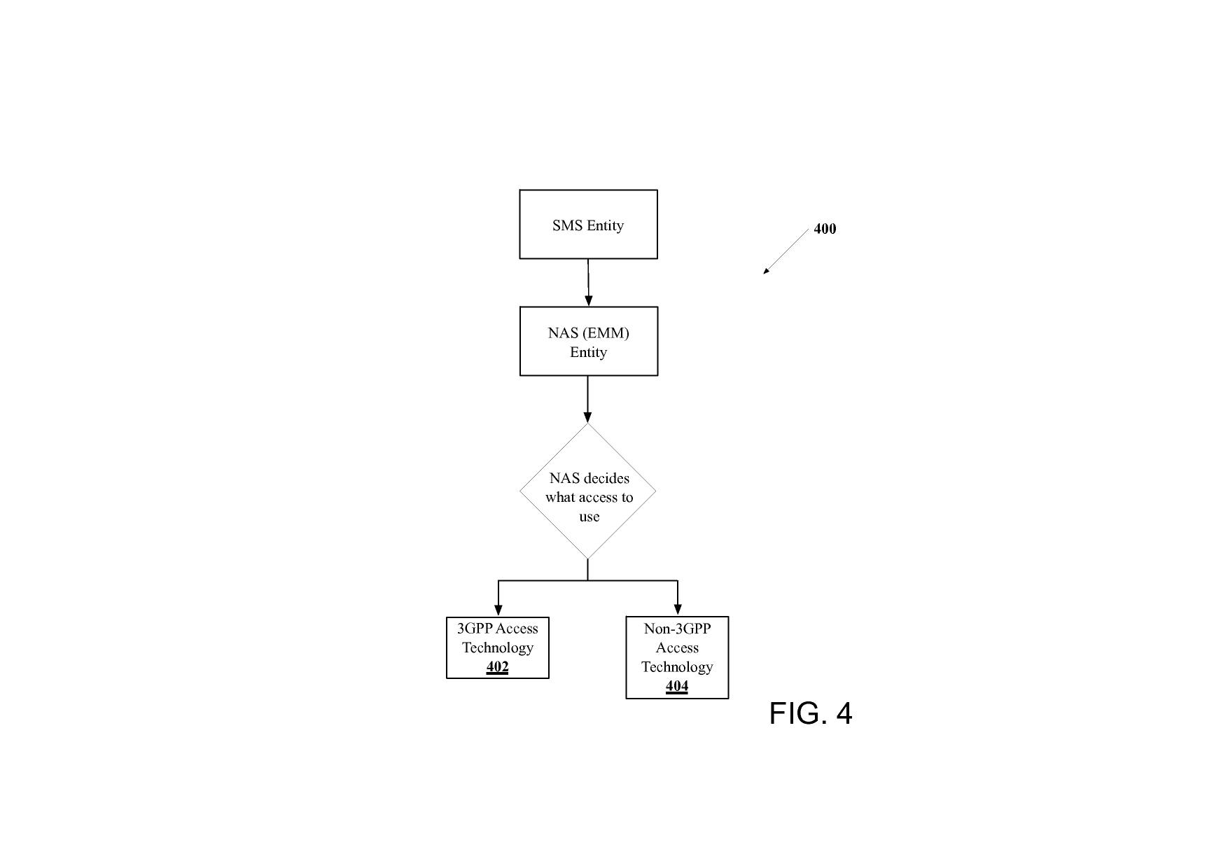

The SMS entity may provide the NAS (e.g., EMM) entity with an SMS for transmission and the NAS EMM entity may decide if the SMS should be sent over 3GPP or non-3GPP access technology. The NAS EMM entity may verify its configuration for SMS transmission as disclosed herein. This is shown in FIG. 4, which illustrates an example NAS decision 400 to use 3GPP Access 402 or non-3GPP Access 404 for an SMS Transmission.

In another example, the SMS entity may be aware of what access technology to use based on configurations as disclosed herein. The SMS entity may decide to send the SMS over a non-3GPP RAT. To do so, the SMS entity may directly communicate with the non-3GPP access via another interface. The SMS entity may send the SMS to the NAS entity and indicate if this SMS should be sent over 3GPP or non-3GPP interface. The NAS entity may then send the SMS over non-3GPP (e.g., if informed by SMS entity to do so).

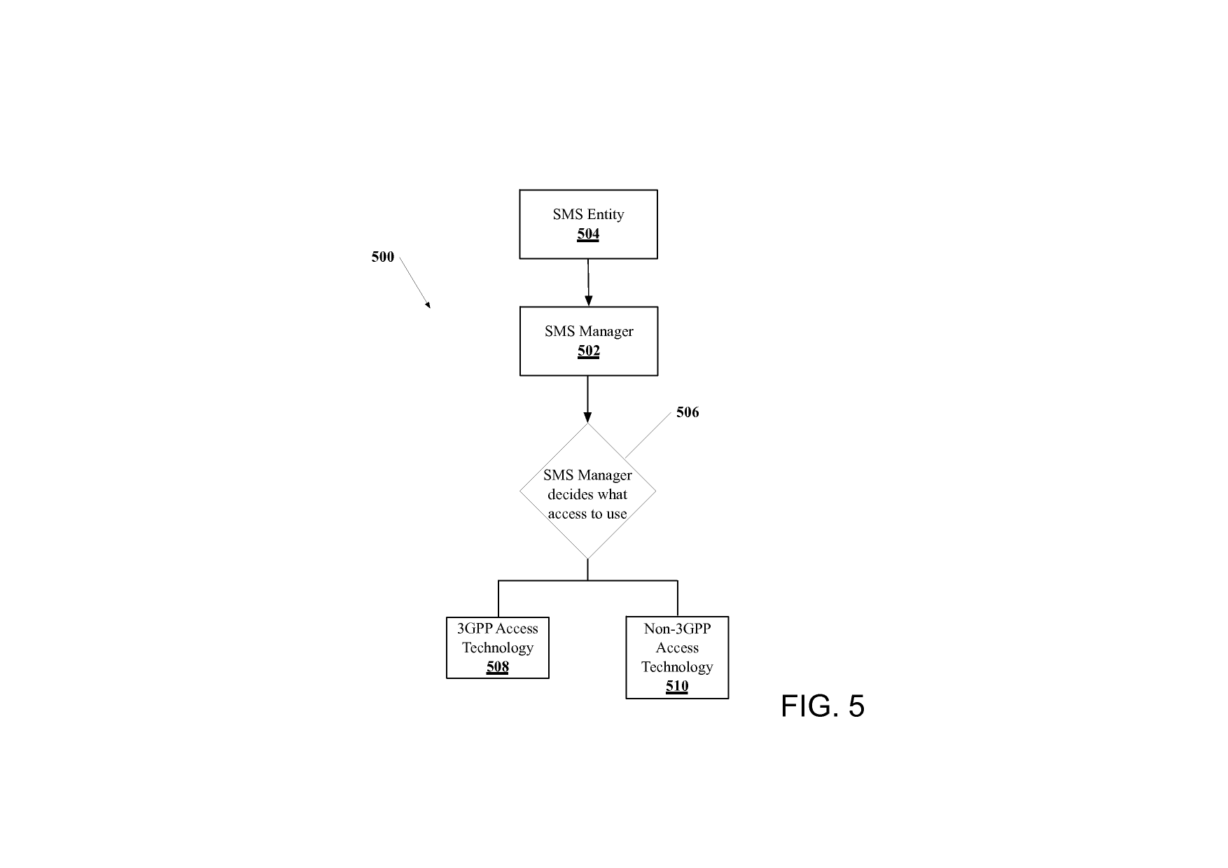

Alternatively, an entity may handle the SMS transmission decisions. This entity may be called, for example, an SMS manager and its function may be to decide, e.g., based on configurations, and the like whether to use 3GPP access technology or non-3GPP access technology for the SMS transmission. This is shown in FIG. 5, which illustrates an example method 500 implemented by an SMS manager 502 to decide which access technology to use for SMS transmission.

The SMS Manager 502 may directly interface an SMS entity 504 as shown in FIG. 5. The SMS entity 504 may directly send the SMS to the SMS Manager 502, which at 506 may decide what access technology to use based on the configurations or policies are described earlier. The SMS Manager may then send the SMS over a 3GPP access technology 508, e.g., by forwarding the SMS to the NAS entity (not shown in FIG. 5), or may forward the SMS to a non-3GPP access technology 510, via another entity or API (not shown above). In another example, the SMS Manager 502 may send the SMS to the NAS entity and indicate the access technology to use. The NAS may then send the SMS via 3GPP access technology 508 or non-3GPP access technology 510 as per an indication from the SMS Manager 502.

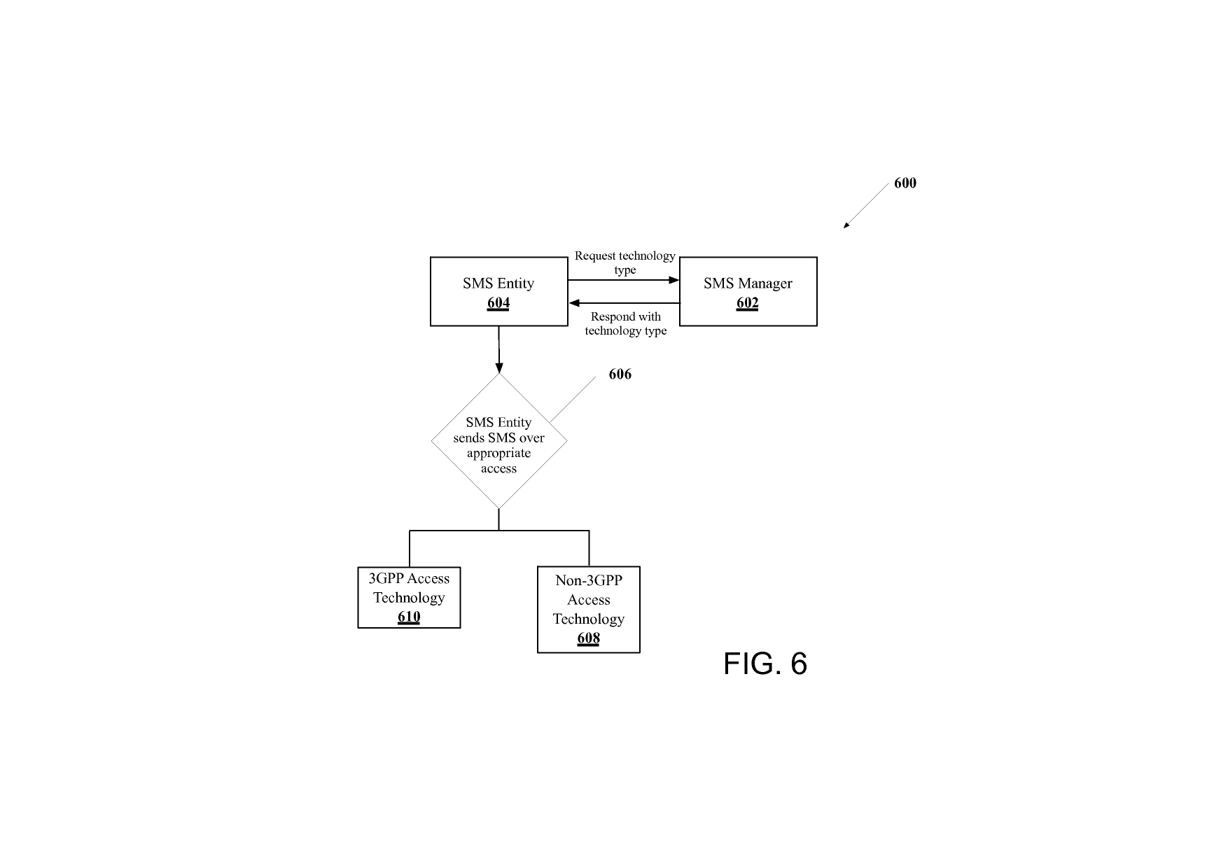

In another example, the SMS entity 504 may probe the SMS Manager 502 to know which access technology should be used. Based on the response from the SMS Manager 502, the SMS entity 504 may then send the SMS over 3GPP access technology 508 or non-3GPP access technology 510 as described herein. This is further described in FIG. 6, which illustrates example SMS entity probes 600 of an SMS manager 602 to decide on what access to use for SMS transmission.

After the response is received from the SMS Manager 602, an SMS entity 604 may then send the message at 606 as per the response. This may be done directly, e.g., with an interface towards a non-3GPP access 608 (e.g., if the decision is to use non-3GPP access 608) or towards a 3GPP access 610 (e.g., if the decision is to use 3GPP access 610), or via another interface or API, or via the NAS entity with an indication of which access to use. The NAS may then send the SMS over the appropriate interface as per the indication.

An interface to the non-3GPP access (e.g., lower layers) may perform the transmission. This interface may exist from the NAS entity to the non-3GPP access; however, the same applies to other entities as well, e.g., the same interface can exist between the SMS-entity and the non-3GPP access technology (e.g., lower layer), or between the SMS Manager and the non-3GPP access technology (e.g., lower layer), depending on the transmission.

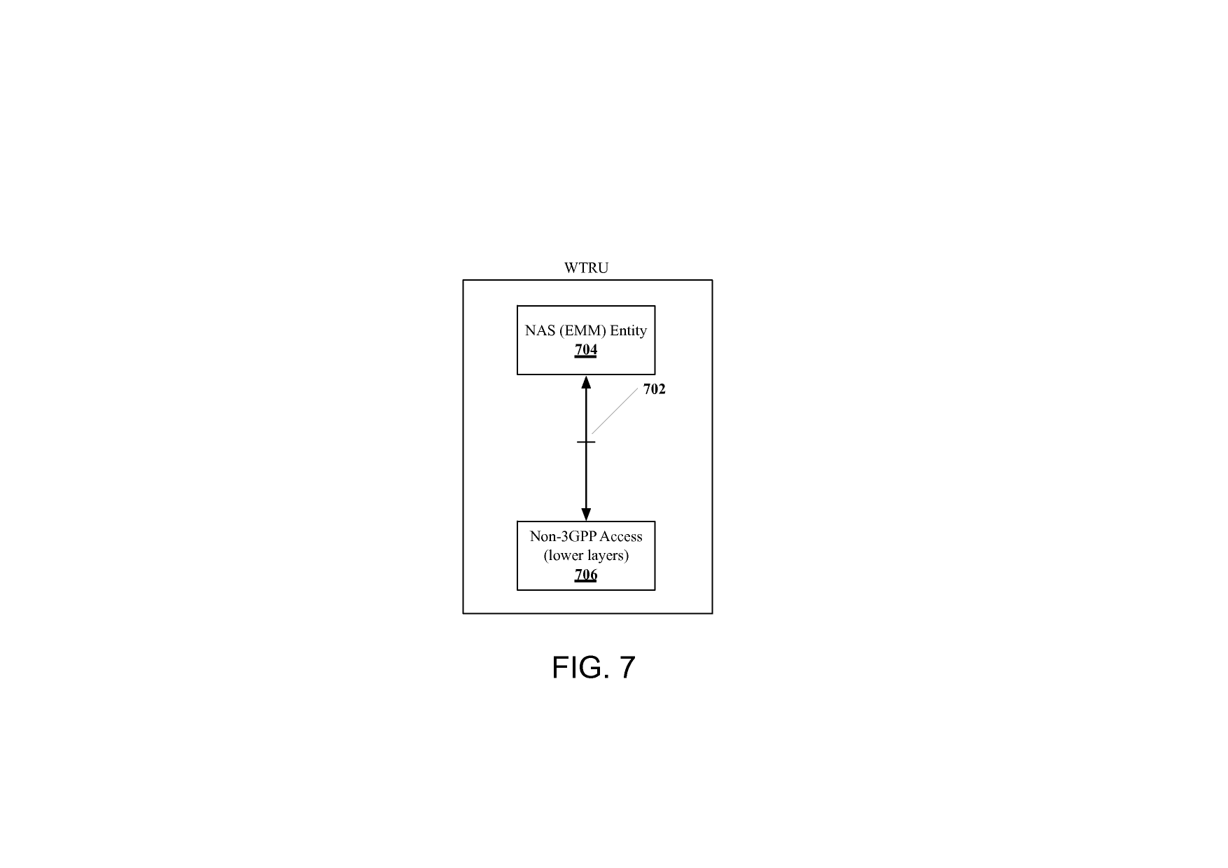

FIG. 7 illustrates an example interface 702 between a NAS entity 704 and a non-3GPP access (lower layer) technology 706. This interface 702 may also exist if the NAS entity 704 is replaced with an SMS entity or an SMS Manager entity. The interface 702 may be used for communication between the NAS entity 704 and the non-3GPP access technology 706. This interface may be realized with an Application Programming Interface (API) or a list of APIs. This interface may provide a number of functionalities, including, but not limited to, communication from the NAS entity 704 to the non-3GPP access technology 706 to send an SMS, e.g., a transmission request; request from the NAS entity 704 to verify if the non-3GPP access technology 706 is connected to an AP and the address or identification of this AP (e.g., MAC address, etc., of the AP); indication from an AP to the NAS entity 704 that a connection has been established or lost with a particular AP; indication from an AP to the NAS entity 704 that SMS transmission support indication has been received or lost from a non-3GPP AP; indication from an AP to the NAS entity 704 that lower layer failure has occurred; and/or indication from an AP to the NAS entity 704 that a transmission (e.g., for SMS, but perhaps not limited to SMS) has been successful or not.

The NAS entity 704 may start a timer to guard from the non-3GPP access technology 706 an indication that a transmission was successful or unsuccessful. The NAS entity 704 may request the transmission of the SMS if no successful confirmation is received from the non-3GPP access technology 706 or from the SMS protocol itself.

The NAS entity 704 or any other entity that is responsible for deciding which access to use may decide to re-transmit an SMS on the same access technology or using another technology, e.g., 3GPP based on N (where N is an integer) failed transmissions, or based on an indication that a connection has been lost with an AP, or based on lower layer failure indications.

For transmission of an SMS, the existing NAS message may be reused for SMS transmission in LTE, e.g., the UL NAS Transport message. The existing NAS message may also be reused for transmission of the SMS message itself The term SMS message may refer to either the actual SMS itself or the UL NAS Transport message, or any NAS message or modified NAS message that may be defined and/or used for sending over non-3GPP access. To send an SMS message, the NAS entity 704 may forward, e.g., via the interface 702 shown in FIG. 7, the NAS message along with other identification information such as, but not limited to, any 3GPP assigned identity (S-TMSI, GUTI, P-TMSI, etc.), an IMSI, MSISDN, a PLMN ID, and/or any RAN ID (e.g., any RNTI that may still be at the eNB even though the WTRU may be in idle mode). To receive an SMS, the non-3GPP access technology 706 may forward the SMS message to the NAS entity 704 along with any received information from the AP, such as 3GPP identities, IMSI, and the like, as disclosed herein. For a mobile terminating SMS, the WTRU may monitor the non-3GPP access for a terminated SMS even if the WTRU is in idle mode with the 3GPP system.

The transfer of SMS or other services is not limited to being performed over the physical or MAC layers of the AP. This may also be done over Internet Protocol (IP). Thus, the SMS message may be sent over IP to the AP. For example, a message may be defined and sent in an IP packet where the message includes the information disclosed herein (e.g., UL NAS Transport, etc.). The IP layer at the AP may then forward the contents (e.g., based on indications in the IP packet, e.g., its header, or based on indications in the physical/MAC layer messages) to another entity, which may then forward the message and information to the eNB.

In an example, modifications may be provided to the messages and/or communication of the non-3GPP access technology 706 of FIG. 7. These modifications may apply to either the physical layer or the MAC layer and may also apply to control or data frames. The non-3GPP access technology 706 may provide an indication as to whether or not an SMS service or other services is supported over the AP. This may be done using broadcast method or dedicated method when a device associates with an AP. The AP may also indicate 3GPP-related information, such as, but not limited to, an eNB ID, a location ID (e.g., tracking area identity), PLMN ID, HNB ID, etc. This may provide an indication as to which PLMN, cell, HeNB, or CSG the AP may be associated with. The AP may also indicate the type of services that are supported, e.g., SMS, location, and the like. These services may include any service that may be supported by the 3GPP system. Hence, the WTRU may use a non-3GPP technology to send or receive them, as with the SMS case. Thus, this may also apply to other services, e.g., location services. The non-3GPP access technology 706 may read this information (e.g., support indication and/or 3GPP related information) and provide it to the NAS entity 704 using the interface 702. The NAS entity 704 or any other entity that may be interfacing with the non-3GPP access may use this information to decide or initiate SMS transmission over the non-3GPP access technology 706. The device may also indicate if it supports SMS over the non-3GPP access technology 706. The physical layer or MAC messages may also include an indication that the data carried is SMS-related or related to any other service, e.g., location service. Thus, when the WTRU receives such a message from the AP, it knows that the message carries an SMS. The non-3GPP access entity may then remove this SMS along with other information (e.g., identification information) and forwards it to the NAS entity. Similarly, when the AP receives such a message that indicates the content to be SMS or other 3GPP related service, the AP may remove the SMS and other information received from the WTRU (e.g., identification information, such as but not limited to, S-TMSI, PLMN ID, and the like) and may forward the content to the eNB, which may be a HeNB/CSG, or the like.

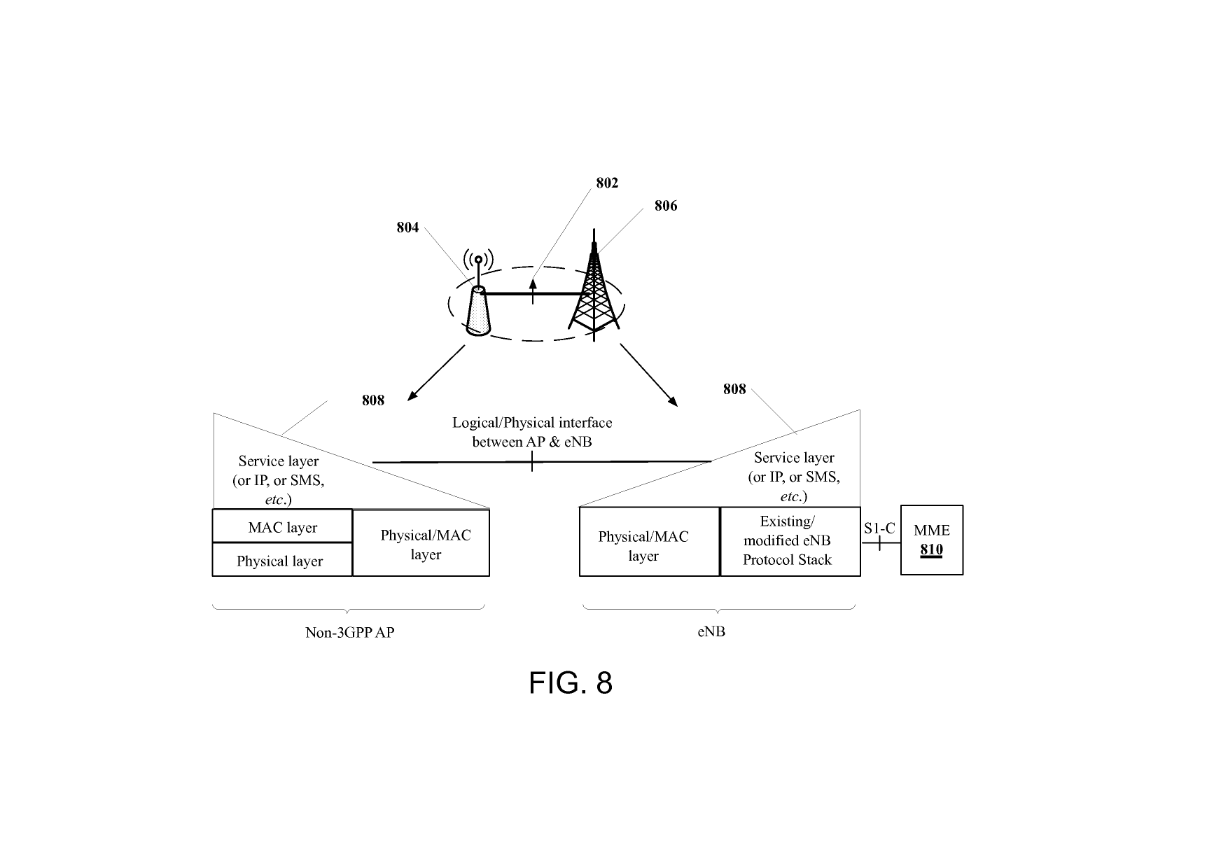

Disclosed herein is an example interface between the AP and the eNB. An eNB may refer to an eNB, HeNB, CSG, RNC, and the like. FIG. 8 illustrates a diagram of an example interface 802 between an AP 804 and an eNB 806. While not shown in FIG. 8, an AP may have multiple interfaces to multiple eNBs simultaneously. Also, while not shown in FIG. 8, an eNB may connect to multiple APs. An entity, which may be referred to as a Service Layer or SMS entity 808, among other terms, may reside in both the AP 804 and the eNB 806. The Service Layer or SMS entity 808 may be responsible to exchange SMS messages between the AP 804 and the eNB 806. This may also be applicable to other messages for other services, e.g., location services. At the AP side, when the SMS message is received from the WTRU by the lower layers, it may be forwarded, along with other identification information, to the Service Layer or SMS entity 808, which may then interwork the message, along with any received information, to be sent to the eNB via an interface that may connect both entities. This interface may be a logical IP connection, or Ethernet, or any medium. The message received at the AP may be in an IP packet. Thus, the Service Layer or SMS entity 808 may reside on top of the MAC or IP layer, which is not shown in FIG. 8.

To forward the message to the appropriate eNB, the AP 804 may be connected to one eNB and thus may forward the message to this eNB. As another example, the AP 804 may maintain a mapping table that indicates where the message should be forwarded, e.g., if the AP 804 connects to multiple eNBs. The AP may use a table that contains the WTRU identity (e.g., 3GPP identification information such as S-TMSI, GUTI, registered PLMN ID, and the like) or other information that may map to the eNB that may handle this message. Thus, the AP 804 may use this mapping table to determine which eNB the message may be sent to. When forwarding the message to the eNB, the AP 804 may include any received information from the WTRU or from its mapping table, such as but not limited to, registered PLMN, S-TMSI, GUTI, MSISDN, and the like. Similarly, when the AP 804 receives a message from the eNB, it may verify for other identification information to know which WTRU the message should be sent to. The AP 804 may also maintain a table that maps the WTRU identification information to the non-3GPP access related identification information that may be assigned to the WTRU or the WTRU's MAC address associated with the non-3GPP interface. Based on this, the AP 804 may interwork the message and may forward it to the appropriate WTRU and may also include additional information, e.g., 3GPP identification information.

At the eNB side, when a message is received from the AP 804 for a particular WTRU, based on identification information provided by the AP 804, the eNB may then forward the message to the appropriate MME/PLMN. The eNB may maintain a mapping or a WTRU context (even though the WTRU is in idle mode) that maps the WTRUs' identities to MME/PLMN. Thus, the eNB may use this mapping/context to forward the message to an MME 810. When a message is received from the MME 810, the eNB may also verify its context information or mapping table to verify which AP this message should be sent. Thus, the eNB may maintain a table that has mapping information, e.g., based on WTRU identification or MME/PLMN identification, to determine which AP to forward the message to. The eNB may interwork the message into a message to go via the interface 802 with the AP 804, e.g., according to the actual protocol used in this connection. The eNB may then send the SMS along with other identification information that it may have received from the MME 810 or from its mapping table/context for the WTRU.

When the AP 804 and the eNB 806 communicate to exchange messages for a particular WTRU, both the eNB 806 and the AP 804 may be allocated a unique identity (e.g., session ID, tunnel ID, eNB address or AP address, and/or the like) that may be used to uniquely identify the WTRU for which the communication is being requested.

In an example, the eNB 806 may maintain some WTRU context even if the WTRU is in RRC idle mode. The context may be in the form of a mapping table and other information; thus, the term context can be used to generically refer to any information that may be maintained for a WTRU when it is in idle mode.

The eNB 806 may begin maintaining a context when any of a number of events occur. For example, the eNB 806 may begin maintaining a context if the MME 810 may inform the eNB 806 about the APs that are allowed for the WTRU in question. This may be done in any existing S1AP message as an additional IE. For example, this may be done in the Initial Context Setup Request message.

As another example, the eNB 806 may start maintaining a context if the WTRU may also indicate whether or not it is associated with an AP and may also report the identity of the AP, e.g., a MAC address of the AP. This may be done in NAS or RRC messages. If done in NAS messages, the MME 810 may then provide this information to the eNB in any S1AP message or via OMA. If the WTRU informs the eNB 806 about association with an AP, the eNB 806 may request the MME to indicate whether such a service is allowed for the WTRU in question. This may be done via any S1AP message that can be modified to achieve this function, or a message may be defined. The eNB may then establish a connection with the AP for the WTRU in question and may then establish a context for the WTRU with the AP. This may also be done if the MME 810 indicates to the eNB which APs are allowed for the WTRU.

As another example, the eNB may begin maintaining a context if the AP 804 may also indicate to the eNB 806 that a particular WTRU is associated with it or connected to it. The WTRU may provide information to the AP about the eNB that it is connected to, along with other information, such as registered PLMN, GUTI, S-TMSI, MSISDN, and the like. This may be done by defining messages or fields in the non-3GPP access communication messages.

The eNB 806 may alternatively start maintaining the context when the eNB 806 serves the WTRU, e.g., upon transitioning to connected mode or after a handover to the eNB 806, or when the eNB releases the WTRU's RRC connection. The MME 810 may also indicate to the eNB 806 per RRC connection release procedure whether or not the WTRU should use a non-3GPP AP to send SMS. This information may be included as additional IEs in existing S1AP messages, e.g., in the WTRU Context Release message.

Thus, the eNB 806 may also indicate to the WTRU whether an SMS should be sent over a non-3GPP access (e.g., with the list of APs that should be used, e.g., the MAC addresses). This may be done in dedicated RRC messages including the RRC Connection Release message. The WTRU may then use this indication or any of the triggers disclosed herein to send/receive SMS over non-3GPP access technology.

The eNB 806 may maintain a WTRU context even if the WTRU is in idle mode. Various types of information may be maintained as part of the WTRU context when the WTRU is in idle mode. For example, the eNB 806 may maintain the S1AP connection with the MME 810 using the same eNB WTRU S1AP ID and MME WTRU S1AP ID. The MME 810 may indicate to the eNB 806, e.g., upon RRC release that the eNB 806 should maintain this or another context. As another example, a different context ID may be created at both the eNB 806 and the MME 810, similar to the WTRU S1AP ID and the MME WTRU S1AP ID, and maintained for transfer of SMS over the S1 interface.

In another example, the eNB 806 may also maintain the identity of the MME that is serving the WTRU along with any allocated NAS identities such as, but not limited to, S-TMSI, GUTI, and the like. This information may also be provided by the MME or the WTRU. The eNB 806 may also maintain the WTRU's IMSI. This information may be provided to the eNB 806 by the MME or the WTRU.

The eNB 806 may also maintain a list of APs that can be used to serve a WTRU. The eNB 806 may also maintain the identity of the AP to which the WTRU is currently associated (as provided by the MME, AP, or WTRU, or via O&M).

The eNB 806 may delete any RRC security parameters that may have been deleted upon releasing the WTRU's connection.

Once such a context is maintained, or upon other indications from the MME to allow such a service for a WTRU, with at least one AP, the eNB may establish a connection with the AP over the interface 802.

An eNB may be configured, e.g., via O&M to connect to at least one AP. The eNB may then establish a connection for a given WTRU. This may be triggered by the reception of an indication from the MME, e.g., via S1AP messages, or by a reception of an indication from the WTRU that it has established a connection with an AP.

The eNB 806 may use the interface 802 to communicate with the AP 804. A message may be defined on the interface 802 for establishing a communication session with the AP 804 for at least one WTRU. The eNB 806 may send a message to the AP 804 and may indicate that the request is to setup a communication/connection session for a particular WTRU. The eNB 806 may include information such as, but not limited to, the WTRU's PLMN ID, GUTI, MSISDN, or any WTRU reported identity such as the WTRU's non-3GPP interface MAC address, and the like. The eNB 806 may also assign a session ID or an address, similar to a tunnel ID, that may be used by the AP 804 to reference a session for a particular WTRU.

Upon reception of a request to establish a connection/session for a particular WTRU, the AP 804 may create a context locally and save any received information from the eNB 806. The AP 804 may then respond with the WTRU's MAC address, or the AP's MAC address, or any other information that may have been received from the WTRU. The AP 804 may also assign an identity or an address or tunnel ID to uniquely identify the session for the WTRU in question.

The AP 804 may also initiate the connection request towards the eNB 806, e.g., after the WTRU associates with the AP 804 and the WTRU may have reported the eNB identity, PLMN ID, GUTI, S-TMSI, MSISDN, and/or the like.

For any further communication, the eNB 806 may use the allocated identity by the AP 804 in order to identity the WTRU for which the communication is being done. For example, when sending an SMS to the AP 804 so that it is forwarded to the WTRU, the eNB 806 may include the address/session/tunnel ID that was received from the AP 804 as part of the session setup for the WTRU in question. The AP 804 may use this ID to identify the WTRU for which the request is being sent.

Similarly, the AP 804 may use the eNB allocated session/address/tunnel ID that was received from the eNB 806 as part of the session setup for the WTRU in question. This may be used for any subsequent messages/request that are sent to the eNB for a particular WTRU. For example, when the AP 804 sends an SMS to the eNB 806 for forwarding to the MME, the AP 804 may include the session/address/tunnel ID, and the eNB 806 may use this to identify the WTRU for which the request is being sent.

Both the eNB 806 and the AP 804 may include other WTRU information as part of their communication such as MSISDN, PLMN ID, and the like that may have been received from the WTRU.

Other messages may also be defined over the interface 802, and these messages may be used to terminate a session for a particular WTRU or to modify a session for a particular WTRU. These examples may also apply to other services such as location services. For example, a WTRU may also send location services information over a non-3GPP access technology. Similarly, the network may use the AP 804 to forward location services information to the WTRU instead of using the 3GPP RAN. Thus, the messages disclosed herein may be used to modify a session such that other services may be added to a session with an AP for a particular WTRU. Alternatively, sessions and/or connections may be defined on a per service basis.

In an example, a S1AP message between the eNB and the MME may be provided for the purpose of transferring an SMS (or any other service) for a WTRU over a non-3GPP access technology. This message may be used regardless of whether the WTRU is in RRC connected or RRC idle mode with the 3GPP system.

For example, a message, UL Service Transfer, may be defined for eNB-to-MME communication, and another message, DL Service Transfer, may be defined for MME-to-eNB communication. As another example, an existing S1AP message may be used. For example, Uplink NAS Transport and the Downlink NAS Transport may be used for eNB-to-MME and MME-to-eNB communication, respectively. If an existing message is used, additional information elements or indications may be included to indicate that the WTRU in question is served or to be served via a non-3GPP access technology.

The examples disclosed herein may apply regardless of which type of message is used. For example, when the eNB 806 communicates with the MME 810, the eNB 806 may send the message and may include the WTRU's S-TMSI or any other identity, such as GUTI, and the like. In another example, the eNB 806 may also include any WTRU context identifier as disclosed herein. In another example, the eNB 806 may also indicate that the service is provided via a non-3GPP access technology, with the AP identifier, such as, but not limited to, the MAC address of the AP 804. In another example, the eNB 806 may include the SMS message as received from the AP 804.

In another example, when the MME 810 communicates with the eNB 806, the MME 810 may send the message and may include the WTRU's S-TMSI or any other identity, such as GUTI, and the like. The MME 810 may also include any WTRU context identifier as disclosed herein. The MME 810 may also indicate whether or not the message should be sent via the non-3GPP access technology. If the message is to be sent over the non-3GPP access technology, the MME 810 may include the AP identifier to be used by the eNB 806. The MME 810 may also include the SMS message that should be sent to the WTRU.

In an example, the WTRU may be configured to use a non-3GPP access technology for SMS transmission. This configuration may be performed, for example, based on defined triggers or indications from the MME/eNB or the AP, or ANDSF, or WTRU local policy, etc. Furthermore, the WTRU may be configured to use a non-3GPP access technology for both mobile-originated or mobile-terminated SMS. The WTRU may be configured to use a non-3GPP access technology when the WTRU is in idle mode with the 3GPP system and/or when the WTRU is in connected mode with the 3GPP system.

Upon a request from the SMS entity to send an SMS, or when the NAS needs to send an SMS, the WTRU may verify whether the SMS should go over the non-3GPP access technology. This verification may be performed, for example, by the SMS Manager or NAS, or similar components as disclosed herein. If the SMS should go over the non-3GPP access technology, the WTRU may avoid the establishment of a NAS signaling connection and RRC connection. The NAS entity may then provide the SMS message (or UL NAS TRANSPORT message) to the non-3GPP access (lower layers) using the interface 802. The NAS entity may also provide other information to be included in the message, such as WTRU allocated identities (or other identities such as MSISDN, etc.), registered PLMN ID, and the like. The NAS entity may then start a timer to guard the transmission of the message. The WTRU may also include additional information in the UL NAS Transport message (e.g., the SMS message or the NAS message that carries the SMS) to indicate that the WTRU is using a non-3GPP access technology for the transmission. This may be done by defining an IE in the message.

The lower layers of the non-3GPP access technology may then create a non-3GPP related message and include the SMS message. The WTRU may also include indications in the message (e.g., the MAC frame) that the content is for forwarding to the 3GPP network. The WTRU may also indicate that the content is SMS or other 3GPP-related service. The WTRU may then send the message to the AP. The non-3GPP interface may then indicate the result of the transmission to the NAS entity, which may then stop the timer.

Upon reception of a message, such as MAC, etc., by the AP 804, the AP 804 may verify if the message indicates that the service is 3GPP-related, e.g., the message may indicate the content is SMS. The AP 804 may remove the SMS message and any other information and may forward it to higher layers, e.g., a Service layer that may be defined in the AP 804. This layer may then process the information, e.g., to determine which eNB to send the message to. This determination may be based on WTRU-provided information, such as, for example, PLMN ID, HeNB ID, eNB ID, S-TMSI, and the like. The AP 804 may then use any saved context to forward the SMS (along with other information) to the eNB 806 via the interface 802. The eNB 806 may then forward the message to the MME 810.

In an example, the MME 810 may use a message, which may be modified, to send an SMS to the eNB 806 for forwarding to the WTRU. The MME 810 may indicate whether the eNB 806 should use a 3GPP or non-3GPP access technology. The eNB 806 may then send the message to the AP 804 using the methods disclosed herein. The WTRU may monitor the non-3GPP access messages and may receive a non-3GPP access message that may include an indication about the type of data that is carried, e.g., SMS. Based on such indications, the non-3GPP access technology (lower layers) may remove the SMS message along with other received information and may send it to the NAS entity using the interface 802. The NAS entity may then forwards the SMS message to the SMS entity.

In an example, an AP may directly communicate with the MME 810 to send SMS or other messages for a WTRU in question. This may be done, for example, via another secure node or via an IP connection with the PDN GW (e.g., via an ePDG). Thus, a connection may be defined between the AP 804 and the MME 810, via another node such as, but not limited to, the ePDG and/or the PDN GW.

In an example, a WTRU may also indicate to a non-3GPP AP its mode of operation, e.g., whether or not it is a low priority device, or any mode of operation that may be supported or defined for the WTRU. The AP 804 may use this information to decide, for example, based on network policies, load, and/or priority, to provide any service to a particular WTRU. For example, it may be the network policy to use non-3GPP access to support machine type devices or devices that are configured to operate as low priority devices, and the like. Thus, the WTRU may include this information in the non-3GPP messages that it communicates with the AP 804. The NAS entity in the WTRU, or any other entity may indicate to the non-3GPP access technology, e.g., using the interface 802, that the WTRU is operating in a particular mode, e.g., as a low priority device. This information may also be available in the USIM. The WTRU may then include this information in the non-3GPP access messages, e.g., by defining IEs in the non-3GPP control or data frames to include such indications to the AP 804. The AP 804 may also broadcast information about the type of WTRUs that are allowed to use the AP 804 for a particular service. This may be done by defining an IE in the non-3GPP access messages, e.g., control or data. The AP 804 may also broadcast conditions that may trigger the start/stop of using the AP 804 for any service, e.g., the AP 804 may indicate that WTRUs can use the AP 804 when the 3GPP network indicates barring, for example, and the like. This indication may also be done by defining IEs in the non-3GPP access messages, e.g., control or data.

The examples disclosed herein may apply in any combination and may also apply to GERAN/UTRAN systems. Furthermore, the non-3GPP technology is not limited to WiFi and may also use other non-3GPP access technologies. Furthermore, the examples may apply for other services as well and are not limited to SMS services. For example, the examples disclosed herein may apply for other supplementary services or location services in LTE, MDT, and the like.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method comprising:
generating, at a wireless transmit/receive unit (WTRU), a short messaging service (SMS) message; and
providing the SMS message to an access point using a WiFi connection for delivery to a Mobility Management Entity (MME).

2. The method of claim 1, further comprising:
receiving the SMS message at the access point; and
communicating the SMS message from the access point to a base station.

3. The method of claim 2, further comprising:
receiving the SMS message at the base station; and
communicating the SMS message from the base station to the MME.

4. The method of claim 3, wherein the SMS message is communicated from the base station to the MME using an S1AP message.

5. The method of claim 1, further comprising:
receiving the SMS message and an identification of the WTRU at the MME;
verifying the identification of the WTRU; and
in response to verifying the identification of the WTRU, processing the SMS message.

6. The method of claim 5, wherein processing the SMS message comprises forwarding the SMS message to a recipient.

7. The method of claim 1, further comprising indicating, by at least one of the WTRU and the access point, support of SMS over WiFi (SoW) capability.

8. The method of claim 7, wherein indicating support of SoW capability comprises indicating support of SoW capability using subscription information.

9. The method of claim 7, further comprising initiating a SoW session in response to a trigger.

10. A system comprising:
a wireless transmit/receive unit (WTRU) comprising
a processor; and
a memory storing processor-executable instructions that, when executed by the processor, cause the processor to
determine whether to send a short messaging service (SMS) message using a non-3GPP connection or a 3GPP connection;
provide the SMS message to a Non Access Stratum (NAS) entity;
in response to determining to send the SMS message using the 3GPP connection, sending the SMS message using the NAS entity; and
in response to determining to send the SMS message using the non-3GPP connection, providing the SMS message from the NAS entity to an access point using the non-3GPP connection for delivery to a Mobility Management Entity (MME).

11. The system of claim 10, wherein the non-3GPP connection comprises at least one of a WiFi connection and a WiMax connection.

12. The system of claim 10, wherein the processor is configured to determine whether to send the SMS message using the non-3GPP connection or the 3GPP connection in response to a trigger to initiate an SMS over WiFi (SoW) session.

13. The system of claim 12, wherein the trigger is generated in response to the WTRU entering a cell.

14. The system of claim 12, wherein the trigger is generated in response to an indication of support of SoW capability, the indication being generated by at least one of the WTRU and the access point.

15. The system of claim 14, wherein the at least one of the WTRU and the access point is configured to indicate support of SoW capability using subscription information.

16. The system of claim 10, further comprising the access point, the access point comprising:
a processor; and
a memory storing processor-executable instructions that, when executed by the processor, cause the processor to
receive the SMS message; and
communicate the SMS message to a base station.

17. The system of claim 16, wherein the access point is configured to communicate the SMS message directly with the MME.

18. The system of claim 16, further comprising the base station, the base station comprising:
a processor; and
a memory storing processor-executable instructions that, when executed by the processor, cause the processor to
receive the SMS message; and
communicate the SMS message to the MME.

19. The system of claim 18, wherein the base station is configured to communicate the SMS message to the MME using an S1AP message.

20. The system of claim 18, wherein the access point and the base station are configured to communicate the SMS message using an interface residing in the access point and in the base station.

21. The system of claim 11, further comprising the MME, the MME comprising:
a processor; and
a memory storing processor-executable instructions that, when executed by the processor, cause the processor to
receive the SMS message and an identification of the WTRU;
verify the identification of the WTRU; and
in response to verifying the identification of the WTRU, process the SMS message.

22. The system of claim 21, wherein the MME is configured to forward the SMS message to a recipient.
